(19) United States
(12) Patent Application Publication
(10) Pub. No.: US 2025/0370817 A1
(43) Pub. Date: Dec. 4, 2025

(54) ADAPTIVE NETWORK RESOURCE ALLOCATION USING APPLICATION PRIORITIZATION AND DEPRIORITIZATION

(71) Applicant: Microsoft Technology Licensing, LLC, Redmond, WA (US)

(72) Inventor: Char Shing Wilson Ng, Bellevue, WA (US)

(73) Assignee: Microsoft Technology Licensing, LLC, Redmond, WA (US)

(21) Appl. No.: 18/676,151

(22) Filed: May 28, 2024

(51) Int. Cl. G06F 9/50

(52) U.S. Cl. CPC G06F 9/5038

(57) ABSTRACT

The present application provides systems and methods for adaptive network resource allocation using application prioritization and deprioritization. An application prioritization manager (APM) receives data about an application, or other contextual data, from various components, and prioritizes the application's network resources among other applications that are also prioritized. The APM generates scores for different factors that are derived from the data, such as application type, application network usage, whether an application is minimized, or whether an application is in focus, among others. The APM combines the scores for the different factors into a combined score for the application, and prioritizes the application among other applications based on their combined scores. The APM selects a prioritization mechanism for the application based on the combined score, such as traffic shaping, traffic policing, traffic scheduling, or other techniques that control aspects of the network traffic.

### BACKGROUND

Prioritization mechanisms regulate the flow of data packets in a network and avoid congestion. Such prioritization mechanisms reduce the latency and packet loss caused by data transfers. However, many prioritization mechanisms have limitations and challenges that limit their applicability and effectiveness.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and method for adaptive network resource allocation using application prioritization and deprioritization.

In examples, an application prioritization manager optimizes network resource allocation for one or more applications based on various factors. The application prioritization manager receives various signals from various components of a system and identifies values for factors based on the signals. The application prioritization manager then assigns a score to each factor and combines the scores for the factors into one score for each of the one or more applications, which represents the overall priority level of each of the one or more applications. Based on this score, each of the one or more applications may be prioritized or deprioritized among the other applications. Alternatively, the application prioritization manager selects a prioritization mechanism based on the combined score. The operations may be performed as a method in some examples.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example system diagram that implements adaptive network resource allocation using application prioritization and deprioritization in accordance with examples described herein.

FIG. 2 illustrates an example system diagram that implements an application prioritization manager and a resource allocation manager for assigning priorities to applications in accordance with examples described herein.

FIGS. 3A-3E illustrate tables including example signal values and corresponding definitions for the signal values in accordance with examples described herein.

FIGS. 4A-4C illustrate tables including statistics collected for a plurality of applications in order to normalize and calculate priority scores for the applications in accordance with examples described herein.

FIG. 5 illustrates a table including various scenario types for implementing application prioritization in accordance with examples described herein.

FIG. 6 illustrates a method flow for selecting a prioritization manager to perform prioritization for an application in accordance with examples described herein.

FIG. 7 illustrates a method flow for prioritizing an application among one or more other applications in accordance with examples described herein.

FIG. 8 illustrates a block diagram including physical components of a computing device in accordance with examples described herein.

### DETAILED DESCRIPTION

Network congestion is a problem that affects the performance and reliability of data transfers. Prioritization mechanisms are designed to regulate the flow of data packets and avoid congestion. An example prioritization mechanism is the Low Extra Delay Background Transport (LEDBAT) technique, which facilitates the expedient transfer of data on a network by leveraging unused bandwidth for foreground network traffic. Another example prioritization mechanism is the quality of service (QOS) technique, which prioritizes and controls network traffic based on the type, source, destination, and importance of the network traffic. However, many prioritization mechanisms have limitations and challenges that limit their applicability and effectiveness. For example, such prioritization mechanisms are limited to processing Transmission Control Protocol (TCP) traffic, are explicitly enabled by an application or service, are not suitable for interactive or real-time sessions, are too slow to recover the available bandwidth, and/or are unable to maintain a minimum data transmission rate during periods of heavy foreground network traffic.

To improve the user experience and network efficiency, examples described herein identify when and how to apply certain prioritization mechanisms to different processes and/or applications to prioritize, for example, the allocation of computing resources to the different processes and/or applications. Applying prioritization mechanisms to processes and/or application depends on various factors, such as the user interface (UI) state of the process or application (e.g., whether the UI is minimized, maximized, hidden/concealed, obfuscated, in-focus) and the interactivity of the process or application (e.g., when and/or how often a user switches between or otherwise interacts with applications; details of the interactions including time of the interactions, operations performed during the interaction, and results of the interactions; the interaction type, which describes the categorization of processes based on their interaction with UI and system resources). Some processes and/or applications are candidates for such prioritization mechanisms, as they are unattended (e.g., non-interactive) and low-priority, such as background tasks and minimized or hidden windows. Some processes and applications are not suitable for such prioritization mechanisms or may be suitable for other prioritization techniques, as the processes and applications are attended (e.g., interactive) and/or high-priority, such as visible and in-focus applications (e.g., applications that are actively being used by a user), voice over internet protocol (VOIP), or real-time streaming applications. A more comprehensive approach for prioritizing the allocation of computing resources to processes and/or applications is to use a heuristic or a machine learning (ML) model to predict when certain prioritization mechanisms (e.g., LEDBAT or QoS) can be beneficial. This comprehensive approach enhances network performance for and user satisfaction with processes and/or applications by applying applicable prioritization mechanisms and/or prioritization techniques to the processes and applications.

The prioritization logic used by prioritization mechanisms to prioritize processes and applications considers factors important to a user. A user, as used herein, refers to an individual (e.g., an end user of an application) or a group or an entity associated with an individual (e.g., a supervisor, an administrator, or an organization having an administrative role or other fiduciary duties related to the end user or the application). For example, with respect to user satisfaction, applications play a role in shaping the user experience, and their importance can be discerned through various indicators. Determining the aspects of applications that are important for maintaining a good user experience is relevant to determining which information should be monitored. For example, user engagement is an indication of an application's importance. Applications that users interact with frequently, such as calendars, messaging apps, or task managers, may be important to the user. High levels of engagement may suggest that these applications are important for the user's productivity and connectivity. Real-time performance is another important aspect. For example, it is important for applications such as multiplayer games, stock trading applications, or live event streaming services to operate with low latency to provide a satisfactory user experience. Delays or disruptions in these applications can lead to frustration and a negative perception of effectiveness. Thus, user satisfaction may dictate a prioritization mechanism's prioritization of processes or applications and the importance of processes or applications to a user.

In other examples, data sensitivity dictates a prioritization mechanism's prioritization of processes or applications and the importance of processes or applications to a user. It is important that applications that manage financial transactions, personal communications, or health records maintain a secure environment and quickly respond to user inputs to maintain trust and reliability. Collaboration tools, such as video conferencing software and shared workspaces, are important in a remote or hybrid work setting. Such applications may be prioritized to facilitate smooth teamwork and communication. For creative professionals, applications related to content creation (e.g., digital art software and video editors), are important to maintaining a good user experience. Regarding education and personal development, e-learning platforms, interactive learning tools, and test-taking platforms may be important for user experience and information fidelity. These applications must be responsive and accessible to provide a conducive learning environment. Applications offering accessibility features are vital for users with impairments. Prioritizing applications ensures that users have an equitable experience. Environmental context also dictates a prioritization mechanism's prioritization of processes or applications and the importance of processes or applications to a user. Environmental context describes where applications are being run and who is using the applications. For example, systems run by a financial institution may place importance on financial-related applications over other types of applications. In another example, educators may place importance on audio quality to ensure that important portions of lectures are not missed.

In accordance with examples described herein, the present application provides systems and methods for adaptive network resource allocation using application prioritization and deprioritization. In some examples, an application prioritization manager (APM) receives information about an application or other contextual information (e.g., user preferences, application usage patterns, and network usage priorities) from various components of a system. Based on the received information, the APM prioritizes the application among one or more other applications, which causes network resources (e.g., bandwidth, throughput, processing power, buffer space in routers or switches, peripheral devices, files, security) of the system to be allocated to (e.g., prioritized for) the prioritized applications. For example, the APM receives one or more signal values from various components of a system, where the signal values indicate the information about the application. The signal values, which may be numeric, textual, Boolean, data, quantify or otherwise specify information (e.g., raw information or contextual information) about the application. The APM then generates scores for different factors that are derived from the signal values. In examples, factors include application type, application network usage, whether an application is minimized, whether an application is in focus, and/or rules/policies used to determine an application's “usage state” or “availability state”, among others.

In some examples, the APM identifies values of factors based on the signal values (e.g., a signal value of “500 KB” for the network usage factor, a signal value of “1” for the application type factor). These values of factors may be the signal values themselves or may be generated by the APM based on the signal values. For example, the application type is APM-generated based on a signal value (e.g., the signal value “1”) that indicate the probable application type of the application. For instance, the APM may have access to a lookup table comprising correlation between signal values and application types (e.g., signal value “1” is correlated to a spreadsheet application, signal value “2” is correlated to a presentation application, signal value “3” is correlated to a word processing application). In some examples, the APM generates individual scores for factors based on the values of the factors. The scores may be weighted and/or normalized, as described later. The APM determines the weights in various ways (e.g., using ML-based models). In some examples, the APM combines the scores for the different factors into a combined score for the application and prioritizes the application among other applications based on the combined scores of the applications. In some examples, a given prioritization mechanism may be selected from a plurality of prioritization mechanisms depending on the combined score for the application, as described later.

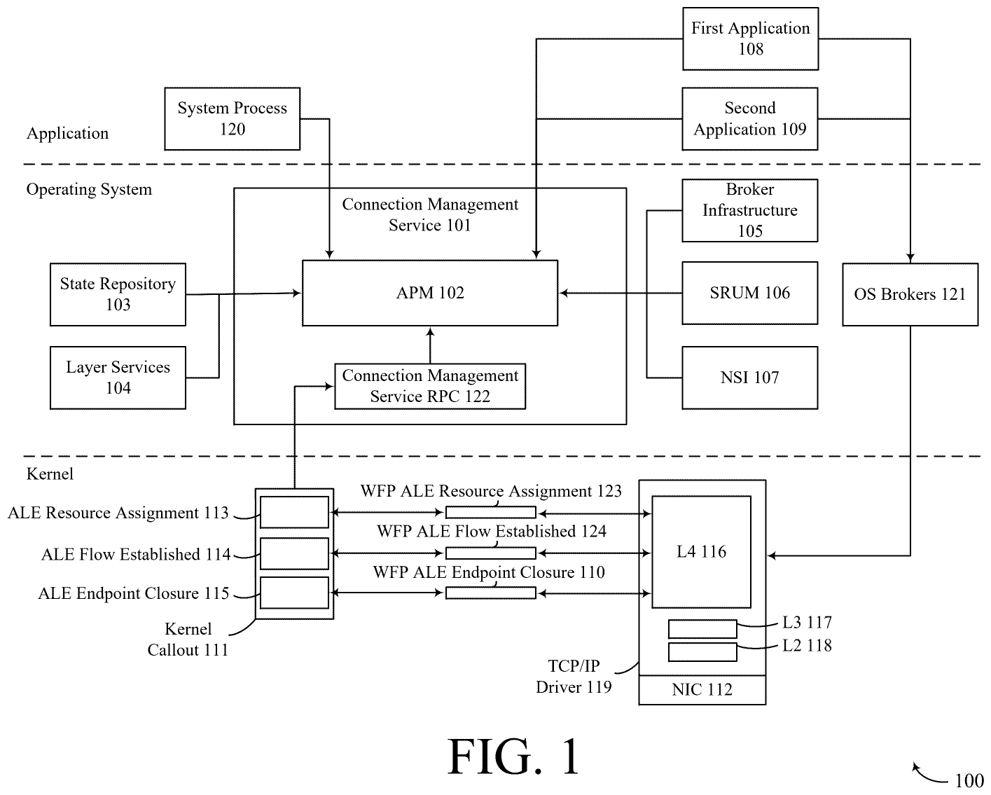

FIG. 1 illustrates a system that implements systems and methods for adaptive network resource allocation using application prioritization and deprioritization. System 100, as presented, includes a combination of interdependent components that interact to form an integrated whole. Components of system 100 include hardware components or software components (e.g., application programming interfaces (APIs), modules, runtime libraries) implemented on and/or executed by hardware components of system 100. In some examples, components of system 100 are distributed across multiple processing devices or computing systems. Alternatively, system 100 is implemented on a single processing device or computing system. Additionally, while the present disclosure provides examples of prioritizing and/or deprioritizing applications, it will be understood that examples are similarly applicable for prioritizing and/or deprioritizing processes, programs, or the like.

System 100 includes connection management service 101, APM 102, state repository 103, network layer services 104, broker infrastructure 105, System Resource Utilization Monitor (SRUM) 106, Network Services Interface (NSI) 107, first application 108, second application 109, kernel callout 111, network interface card (NIC) 112, TCP/internet protocol (IP) (TCP/IP) driver 119, system process 120, and operating system (OS) brokers 121. Kernel callout 111 includes Application Layer Enforcement (ALE) resource assignment 113, ALE flow established 114, and ALE endpoint closure 115. TCP/IP driver 119 interfaces with fourth layer (L4) 116, third layer (L3) 117, and second layer (L2) 118. Connection management service 101 includes a component for connection management service remote procedure call (RPC) 122. The scale and structure of devices and environments discussed herein vary and include additional or fewer components than those described in FIG. 1 and subsequent figures. For example, while APM 102 is illustrated as being implemented by connection management service 101, it should be noted that APM 102 is a standalone service in system 100 or is implemented in a different service or component.

Connection management service 101 determines whether to connect to or disconnect from different types of networks (e.g., Ethernet, Wi-Fi, and/or mobile broadband). In some examples, connection management service 101 handles VPN connections and network diagnostics. Connection management service 101 collects signal values from other components (e.g., state repository 103, network layer services 104, broker infrastructure 105, SRUM 106, NSI 107) that provide information about the network availability, quality, and preferences, as described later. Based on these signal values, connection management service 101 determines the best network to use for each connection scenario. For example, connection management service 101 can switch from Wi-Fi to mobile broadband when the Wi-Fi signal is weak or unreliable, or connection management service 101 can disconnect from a network when a better network (e.g., having higher signal strength, lower latency, or higher throughput) becomes available. In some examples, connection management service 101 is a system service (e.g., runs at the system level). However, in some examples, connection management service 101 runs under a local service account (e.g., runs at a user level) to maintain security.

In some other examples, connection management service 101 includes a network list service. A network list service maintains a list of all the networks to which the device has connected, and provides information about the device's names, categories, and connectivity states. The network list service also notifies applications and other components when the network status changes. The network list service may collect signal values from one or more components (e.g., state repository 103, network layer services 104, broker infrastructure 105, SRUM 106, NSI 107).

APM 102 manages the performance and user experience of different applications based on, for example, network conditions, user preferences, and the like. For example, APM 102 determines which applications to prioritize over others by ranking, scoring, or other mechanisms. In some other examples, APM 102 prioritizes the network traffic of certain applications over others, and/or adjusts the application settings to reduce bandwidth consumption or improve quality. APM 102 tracks one or more application's process state, metadata info, interactivity, network usage, and/or any relevant connection metrics/statistics, and aggregates relevant events and/or activity metrics.

APM 102 is implemented in substantially any system service that has the capability to connect to different data sources and/or collect information that APM 102 can use to make prioritization decisions. For example, APM 102 is implemented in connection management service 101, or any other service. APM 102 uses connection management service 101 to access (e.g., receive) signal values from other components (e.g., state repository 103, network layer services 104, broker infrastructure 105, SRUM 106, NSI 107, first application 108, second application 109) as described later, and/or to execute one or more prioritization actions on network interfaces. For example, APM 102 may prioritize or deprioritize one or more applications among a plurality of applications and determine prioritization mechanisms to apply to the plurality of applications based on whether an application that has been prioritized, deprioritized, or priority remains unchanged.

APM 102 receives signal values from various components (e.g., state repository 103, network layer services 104, broker infrastructure 105, SRUM 106, NSI 107) for different applications that indicate information important for a user experience and/or important for prioritizing the applications among one another. For example, APM 102 may receive a signal value from broker infrastructure 105 indicating a number (e.g., 50) of interactivities by a user with a given application (e.g., within a time period).

APM 102 generates or otherwise identifies factor values for prioritizing an application based on the received signal values. A given factor is derived from multiple signals. For example, the factor “application type or category” is derived from multiple signal values including capability, appCategory, and/or application prioritization class. APM 102 combines signal values to derive a factor value when multiple signal values indicate a factor. For example, APM 102 receives signal values for capability and application prioritization, independently analyzes these received signal values, and chooses an application type or category from a predefined list of application types or categories based on the analysis. For example, if an application has gaming capabilities, is labeled as “Games” for its category, and has a low priority class (e.g., games may not be critical processes), the application is categorized as a Game, which may correspond to a number or value for the application type. Substantially any mathematical techniques are contemplated to derive a factor value from multiple signal values (e.g., addition, subtraction, weighted addition, weighted subtraction, normalization of signal values, comparing signal values to thresholds and selecting factor values based on the comparisons). Alternatively, a factor value may be indicated by a single signal value. In such examples, the factor value and signal value are the same. For example, the factor IsAppNotMinimized may be derived from a single signal value that provides a Boolean indicating whether a given application is minimized or not.

APM 102 receives signal values from various components (e.g., APIs, data logs, event services) indicating the signal values. The signal values may be related to the following high-level data and system related information (e.g., factors) for application prioritization. For example, APM 102 gathers information about application usage and performance (e.g., response time, throughput, download/upload time, protocol, number of connections/ports) and network usage and performance (e.g., network bandwidth, throughput, latency, jitter, packet loss). APM 102 may also gather information about an application by collecting metadata about each application (e.g., application name, version, publisher, and category (browser, media streaming, etc.), and model. APM 102 uses this information to determine the characteristics and underlying requirements of each application.

In some examples, APM 102 gathers user-specific contextual information (e.g., user preferences, usage patterns, and network usage priorities) and user engagement information describing user interaction with each application (e.g., the time of day the application is most used, the duration of usage, the frequency of usage). APM 102 uses this information to personalize the application prioritization based on individual user needs. For example, user-specific contextual information indicating that a user historically does not use email after 5 PM is used to configure the user's email application such that the email application is deprioritized with respect to other applications after 5 PM. Configuring the user's email application to be deprioritized may include adjusting settings of the email application, such as an application priority setting or other performance impacting settings (e.g., power consumption settings, bandwidth usage settings, thread concurrency settings). APM 102 may also gather information about the type of network connection and current network conditions (e.g., network congestion, quality, available bandwidth, and latency). APM 102 uses this data to adapt the application prioritization based on the network environment. For example, network condition information indicating that available bandwidth is currently low is used to prioritize multimedia applications (e.g., gaming applications, video player applications, audio player application) and high-interaction applications (e.g., texting applications, social media applications, news applications). Configuring the multimedia applications and high-interaction applications may include adjusting settings of such applications, as discussed above with respect to prioritizing applications based on user-specific contextual information.

In some examples, APM 102 identifies the software dependencies of each application, such as software libraries and other code files, frameworks, and services upon which an application relies. APM 102 uses this information to determine the impact of network usage of an application on other components of the system. APM 102 also monitors application and system level resource usage (e.g., central processing unit (CPU) utilization, memory usage, and disk input/output (I/O)). APM 102 uses this information to determine insights into the system load with respect to application usage and to inform decisions about app prioritization. In some examples, APM 102 maintains a historical record of network usage patterns and application prioritization decisions. APM 102 uses this data for training and improving a machine learning model (e.g., used by APM 102) over time.

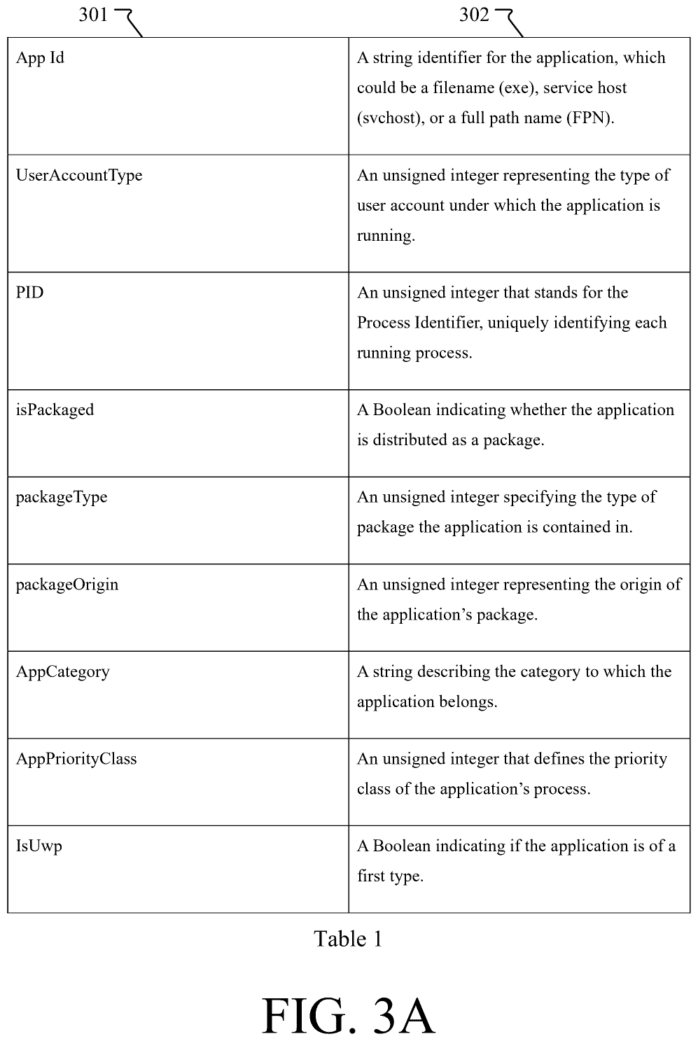

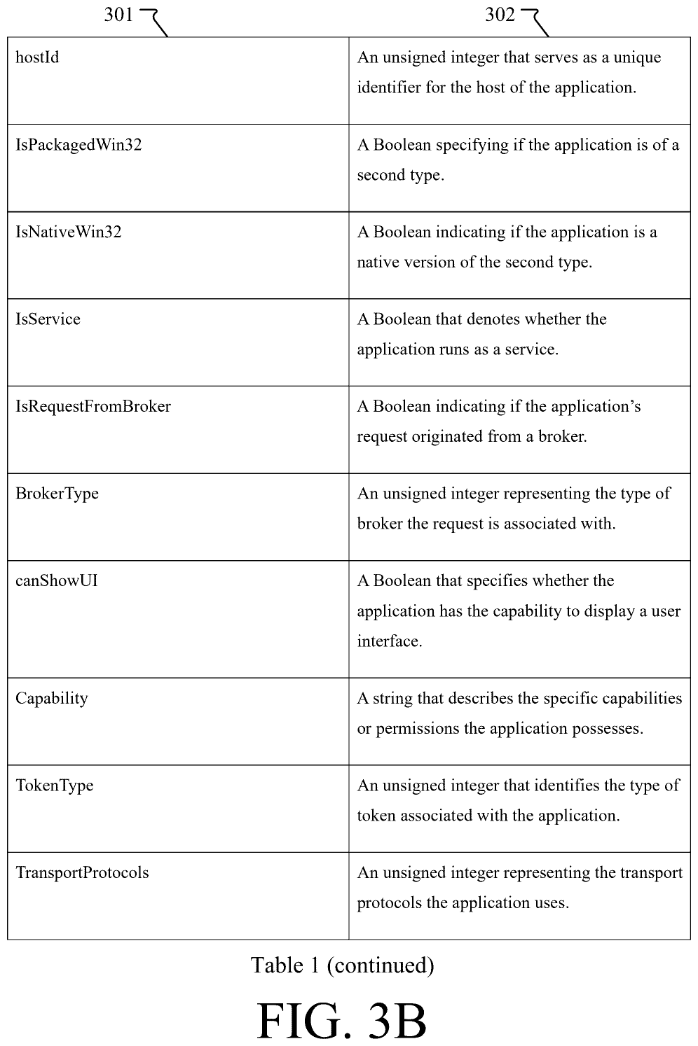

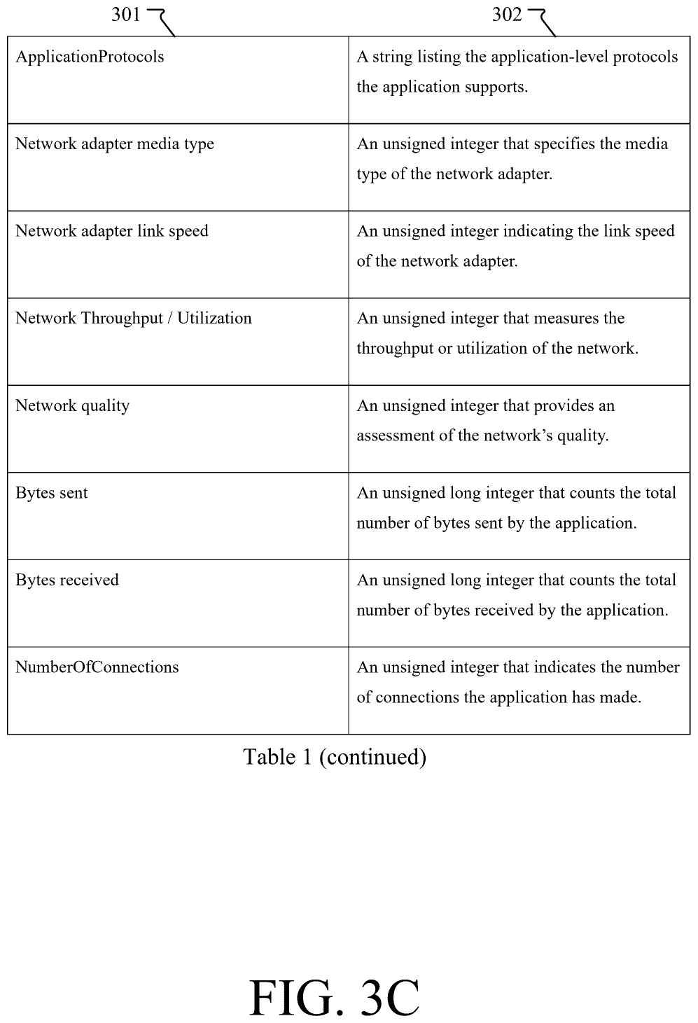

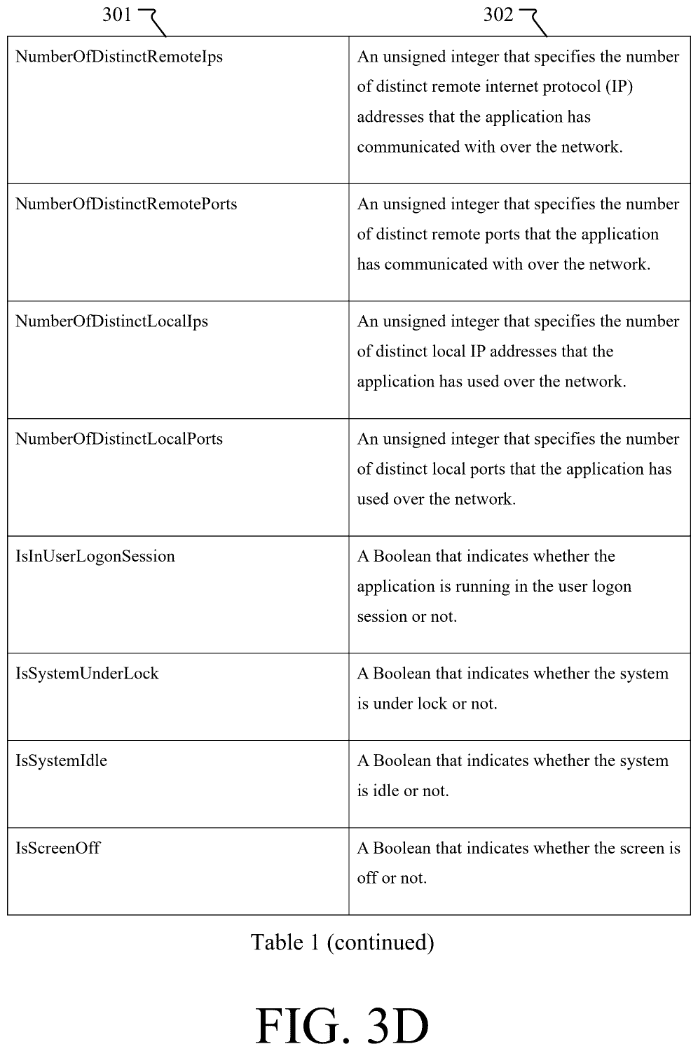

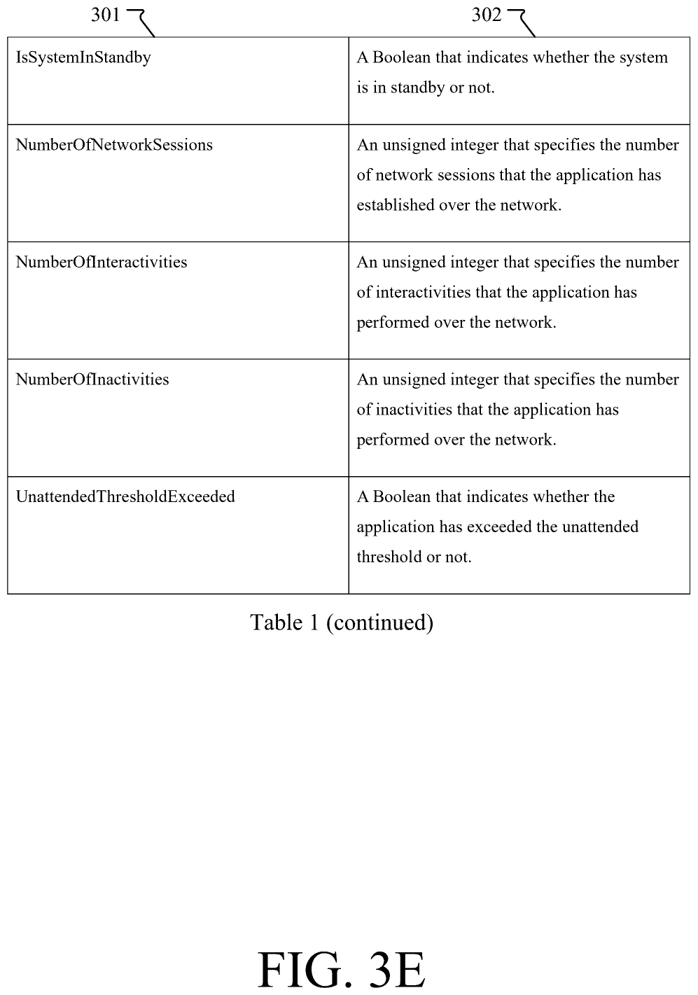

A non-exhaustive list of signal values that may be received by APM 102 is provided in Table 1 of FIGS. 3A-E. Column 301 of Table 1 includes a list of names for the signal values and column 302 includes a list of descriptions corresponding to the signal value names.in column 301.

APM 102 generates factor scores based on the factor values. In some examples, APM 102 weights one or more factor values to achieve factor scores. For example, APM 102 weights factors differently depending on their importance to a user experience (e.g., accessibility, performance, applications that are in the foreground, reduced screen delays) and/or importance to determining application priority. In one example, the type or category/subcategory of an application has a higher weight than the current/history network data usage, as some applications are more important to a user than other applications. For example, a video application that is playing in the foreground (e.g., the application is running and is visible on some portion of a user interface) of an operating system may be more important to the user experience than an update application that is performing a download in the background of the operating system, even though the network data usage of the background download may be higher or have the potential to be higher than the network data usage of the video application. In this example, the video application is assigned a factor value for the application type factor (e.g., “Video”), a factor value for the execution status factor (e.g., “Foreground”), and a factor value for the network data usage factor (e.g., “Medium”), and the update application is assigned a factor value for the application type factor (e.g., “Update”), a factor value for the execution status factor (e.g., “Background”), and a factor value for the network data usage factor (e.g., “High”). Based on these assigned factor values, the weight for the application type factor for the video application is higher than the weight for the application type factor for the update application (indicating that the application type factor for the video application is more important than that of the update application) and the weight for the execution status factor for the video application is higher than the weight for the execution status factor for the update application (indicating that the execution status factor for the video application is more important than that of the update application), although the weight for the network data usage factor for the video application is lower than the weight for the network data usage factor for the update application (indicating that the network data usage factor of the update application is more important than that of the update application).

The weights may be assigned to different factors based on the preferences of the user and/or impact of different factors on the aspects that the user considers important as discussed previously. In some examples, APM 102 allows the user (e.g., an end user, a system administrator, or a network operator) to specify their preferences for the weights in various ways. For example, APM 102 provides a UI that allows the user to select or adjust the weights for different factors or applications. The UI displays a list of factors or applications and their corresponding weights, and allows the user to drag a slider or enter a value to change the weights. Alternatively, the UI displays a list of predefined profiles or scenarios that have different weights for different factors or applications, and allows the user to select one of the profiles or scenarios. APM 102 provides an API that allows the user to configure or modify the weights for different factors or applications. The API accepts, for example, a JavaScript Object Notation (JSON) or Extensible Markup Language (XML) file that contains the weights for different factors or applications, and apply them to APM 102. A JSON file is a text file that stores data in JSON format. A JSON file uses key-value pairs and arrays to represent data, and is commonly used for transmitting data between a web application and a server. JSON files typically have a .JSON extension. An XML file is a text file that stores data in XML format. It uses tags to define the structure of the data and is both human-readable and machine-readable. XML files are used for a wide variety of purposes, including web development, and typically have a .xml extension. Alternatively, the API accepts a command or a query that specifies the weights for different factors or applications, and executes the command on APM 102. APM 102 provides a feedback mechanism that allows the user, to rate or comment on the prioritization actions and the resulting user experience. The feedback mechanism displays, for example, a star rating or a thumbs up/down button that allows the user to express their satisfaction or dissatisfaction with the prioritization actions. Alternatively, the feedback mechanism displays a text box or a voice input that allows the user to provide their suggestions or complaints about the prioritization actions.

Additionally or alternatively, the weights are assigned to different factors by ML models (e.g., deep learning models) that have been trained to determine the importance of various factors to the user experience. To assign the weights using ML models, APM 102 uses various types of ML techniques, such as supervised learning, unsupervised learning, reinforcement learning, or deep learning. For example, APM 102 uses supervised learning to train a regression model that predicts the combined score of an application based on the input features (e.g., the scores for different factors). The regression model uses a linear or a nonlinear function that maps the input features to the output score. The regression model learns the parameters of the function by minimizing the error between the predicted score and the combined score. In another example, APM 102 uses unsupervised learning to cluster the applications into different groups based on the similarity of the input features for the applications. The clustering model may use a distance or a similarity measure that quantifies the similarity between two applications based on the input features. The clustering model learns the number and the location of the clusters by maximizing the intra-cluster similarity and minimizing the inter-cluster similarity. In practical terms, this process of clustering involves analyzing the data points and finding patterns that can group the data points together. For instance, in a dataset of consumer preferences, the clustering model might discover that certain shopping behaviors cluster together, indicating a specific market segment. The ‘number’ of clusters refers to how many of these distinct groups exist within the dataset, while the ‘location’ of clusters refers to the defining characteristics that describe the center of each group. By maximizing the similarity of data points within each cluster, the model ensures that each group is as cohesive as possible. Conversely, by minimizing the similarity between different clusters, the model ensures that each group is clearly differentiated from the others, allowing for distinct categorization of the data.

In yet another example, APM 102 uses reinforcement learning (e.g., using deep learning models) (e.g., TorchRL, Tianshou, CleanRL, OpenAI Gym) to learn from the feedback of the user or the system on the prioritization actions and adjust the weights accordingly. The reinforcement learning model may use a reward or a penalty signal that indicates the accuracy of the prioritization action based on the user or the system feedback. The system can autonomously generate feedback through an environment model that simulates potential outcomes, providing a reward or penalty without direct user input. Predefined system rules and historical data analysis also contribute to the feedback mechanism, allowing the model to independently evaluate and learn from the prioritization actions. The reinforcement learning model learns the policy or the strategy that maximizes the cumulative reward or minimizes the cumulative penalty over time. In still yet another example, APM 102 extracts high-level features from the raw signals and use the high-level features to assign the weights. High-level features are abstract representations that a model extracts from raw data, which are informative for making predictions or decisions. For example, in image processing, high-level features include edges, corners, and textures, while in audio processing, high-level features include pitch, tone, or rhythm. The learning model may use a neural network that consists of multiple layers of artificial neurons that process the raw signals. The model learns the ML weight parameters or the connections between the artificial neurons by optimizing a loss or a cost function that measures the difference between the desired output and the actual output.

APM 102 uses different sources of data to train and update the ML models. For example, APM 102 may use historical data from the state repository 103, network layer services 104, broker infrastructure 105, SRUM 106, NSI 107, first application 108, second application 109, or other components to learn the patterns and trends of the application behavior and user preferences. In some examples, the historical data includes the past records or logs of the application type, network usage, interactivity frequency, inactivity duration, and other factors or features that affect the prioritization. The historical data may also include previously determined scores or rankings for the applications. As one example, a user (e.g., a developer or and administrator) may have previously annotated a set of historical data to include scores, rankings, and other annotations (e.g., data labels, tags, or metadata) related to one or more applications. As another example, a scoring mechanism (e.g., a set of rules, a scoring model or engine, or another decision logic component of system 100) may have been used to annotate a set of historical data related to one or more applications. In such examples, the annotations provide context to the raw information in the historical data to enable the ML models to be trained to recognize patterns, make predictions, and perform tasks (e.g. assigning wights to application-related factors). In some examples, APM 102 uses real-time data from the connection management service 101 or other components to monitor the current network conditions and user feedback. In some examples, the real-time data includes the current status or events of the application type, network usage, interactivity frequency, inactivity duration, and other factors or features that affect the prioritization. The real-time data may also include the current scores or rankings of the applications based on the prioritization actions and the user experience. In some examples, APM 102 uses online or offline learning methods to update the ML models periodically or continuously. The online learning method updates the ML models incrementally or sequentially as new data arrives. For example, online learning methods like Incremental Stochastic Gradient Descent could be employed to adjust the model parameters in real-time as new data streams in. Alternatively, Passive-Aggressive algorithms might be utilized for their quick adaptability to new data. The offline learning method updates the ML models in batches or in chunks after a certain amount of data is collected. For example, offline learning methods such as Q-learning could be applied to train the model on a comprehensive dataset, with retraining occurring when new data batches are available. Deep Q-Networks (DQN), which combine Q-learning with deep neural networks, or Deep Deterministic Policy Gradients (DDPG), which learn a Q-function and a policy concurrently, may also be used for periodic model updates based on accumulated data.

APM 102 uses different criteria to evaluate the performance and accuracy of the trained ML models. For example, APM 102 uses metrics such as mean squared error, mean absolute error, coefficient of determination, or F1-score to measure the quality of the regression, clustering, classification, or ranking models. The mean squared error or the mean absolute error measures the average difference between the predicted score or ranking and the actual score or ranking. The coefficient of determination measures the accuracy of the match between the predicted score or ranking and the actual score or ranking. The F1-score measures the balance between the precision and the recall of the classification or the ranking model. Such metrics quantify the error of the trained ML model predictions during a validation phase.

APM 102 uses methods such as cross-validation, bootstrapping, or testing on unseen data to validate the generalization and robustness of the ML models. Unseen data refers to new data that the model has not been exposed to during the training phase. Unseen data is a separate dataset used to test the model's predictions and assess its generalization capabilities. The cross-validation method separates the data into multiple subsets and uses some of the subsets for training and some of the subsets for testing. The bootstrapping method generates multiple training and testing datasets by sampling the original data with replacement, ensuring that each sample can be selected more than once for both training and evaluation purposes. The testing on unseen data method uses a separate dataset that is not used for training for testing.

APM 102 uses techniques such as feature selection, regularization, or hyperparameter tuning to optimize the ML models and prevent overfitting or underfitting. The feature selection technique selects the most relevant or the most informative features from the input data and discards the redundant or the noisy features. The regularization technique adds a penalty term to the loss or the cost function that reduces the parameters of the ML model and reduces the complexity of the ML model. The hyperparameter tuning technique searches for the optimal values of the parameters that are not learned by the ML model but affect the performance of the ML model. Such parameters include the learning rate, which dictates the magnitude of ML weight parameter updates during training; the number of epochs, which represents how many times the training data is cycled through the model; the batch size, which determines the number of examples used in one update; momentum, which assists in stabilizing and expediting the training process; the regularization constant, which penalizes large ML weight parameters to encourage simpler models; the number of trees in a random forest, which affects both performance and computational load; the number of layers in a neural network, which captures complex patterns; the number of neurons in a hidden layer, which indicates a network's capacity for complexity; and the kernel type used with the ML model, which affects how the ML model handles various data distributions and decision boundaries.

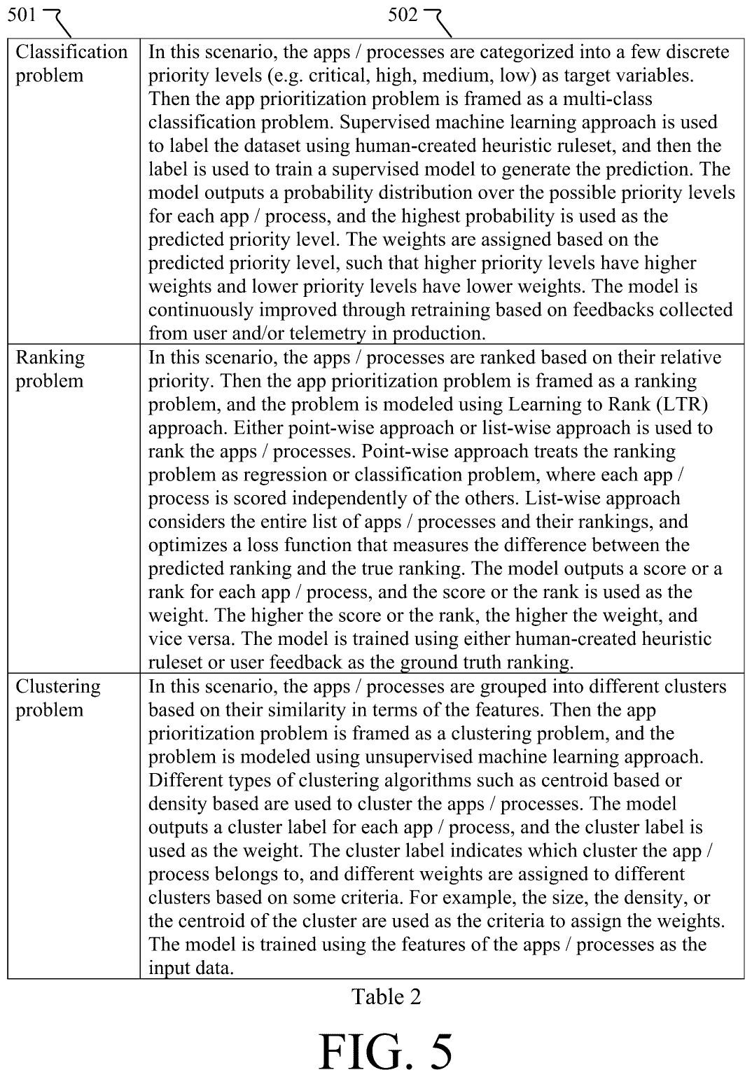

To assign the weights based on ML models, different scenarios are implemented depending on the nature of the problem and the data. A few example scenarios are provided in Table 5 of FIG. 5. Column 501 of Table 5 includes a list of scenario names and column 502 includes a list of descriptions corresponding to the scenario names.in column 501.

APM 102 uses different methods to combine the weight preferences of the user with the weights learned from the ML models. For instance, APM 102 uses a weighted sum or a weighted average to combine the preferred weights and the learned weights. In examples, APM 102 uses a rule-based or a constraint-based approach to enforce the preferences and the learned weights. The rule-based or constraint-based approach uses a set of if-then statements or logical expressions that specify the conditions and actions for the preferences and the learned weights.

APM 102 uses a multi-objective optimization or a multi-criteria decision making technique to balance the preferred weights and the learned weights. In examples, the multi-objective optimization or multi-criteria decision making technique uses a mathematical model that defines the objectives and the constraints for the preferences and the learned weights, and finds the optimal or the best solution that satisfies the objectives. In some examples, APM 102 normalizes the factor values. For example, APM 102 normalizes the factor values between a number range (e.g., 0 and 1). This can be done by dividing each factor value by the maximum factor value among the applications for that factor. For example, if the maximum factor value for the network usage is 500 KB, then the scores for the network usage factor will be divided by 500 to get normalized factor values. In other examples, APM 102 normalizes the factor values using logarithmic scaling (e.g., computing the log of values to compress a wide range of values to narrow range of values), feature clipping (e.g., establishing maximum and minimum values for a dataset and requalifying outlying values of the dataset to the newly established maximum and minimum values), or z-score normalization (e.g., normalizing a dataset based on the number of standard deviations a value is above or below the mean value of the dataset). In some examples, the normalized factor values are updated periodically (e.g., every 30-seconds, hourly, or daily).

APM 102 recalculates the factor values and the combined score for each application based on the latest signal values received from various components. In examples, APM 102 introduces a buffer or threshold of change in priority e.g., an app's priority may change if its new combined score is changed by more than a certain amount of percentage. For example, if the buffer or threshold is set to 10%, then an app's priority may change if its new combined score is increased or decreased by more than 10% compared to its previous combined score. This way, APM 102 reduces the frequency and the magnitude of the changes in the app priority list, and provide a more stable and smooth user experience. Otherwise, without the buffer or threshold, frequent reshuffling of the application priority list could occur, which could introduce unintended disruptive experience to the user. For example, if an application that was previously prioritized drops to a lower priority due to a change in its score, the user experiences a degradation in the quality or performance of the application. Conversely, if an application that was previously deprioritized suddenly rises to a higher priority due to a change in its score, the user experiences an improvement in the quality or performance of the application.

Additionally or alternatively, APM 102 applies an exponential decay approach to give more weight to recent activities than to historical activities, causing the system to be more responsive to changes in user behavior. In some examples, APM 102 applies a decay factor to the current score before updating the new score, where the current score contributes more to the combined score than the older scores. The decay factor, typically a number between 0 and 1, determines the rate at which older data loses relevance. In this context, a decay factor of 0.9 implies that each subsequent score retains 90% of its value from the previous score generation iteration, effectively reducing its influence by 10% each iteration. This method ensures that the system's sensitivity to new data is finely tuned while preventing older data from becoming obsolete too quickly. APM 102 can maintain a dynamic scoring system that accurately reflects the most current user behaviors without being erratic or failing to consider past scores.

APM 102 combines individual scores (e.g., weighted and normalized) for different factors to produce a combined score for the application. APM 102 combines the scores for different factors by applying one or more mathematical operations (e.g., addition, subtraction, multiplication). For example, the combined score is obtained by adding the scores for the application type, network usage, and interactive frequency, and subtracting the score for the inactivity duration.

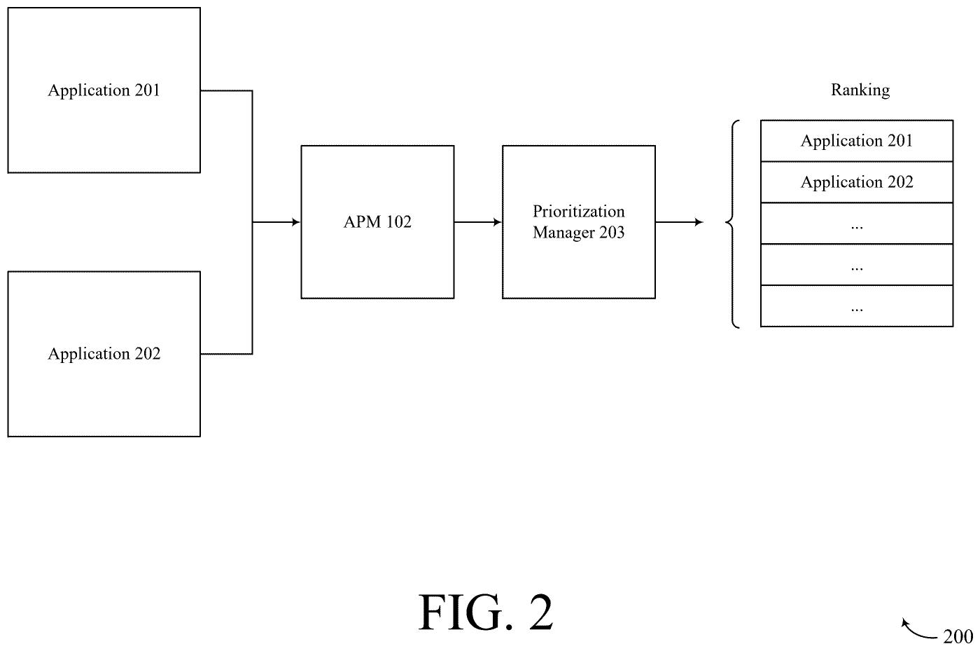

After computing the combined scores for one or more applications, APM 102 or another component, e.g., prioritization manager 203 of FIG. 2, sorts the list of applications based on their combined scores and/or prioritizes the applications using a prioritization mechanism. For example, APM 102 provides the combined scores for each application to prioritization manager 203, and prioritization manager 203 sorts the list of applications based on their combined scores. In some examples, applications with higher scores (e.g., applications with scores greater than or equal to a threshold) are prioritized for resource usage (e.g., network resources, processing resources). In examples, the higher scores indicate the applications that are more frequently used and/or less frequently left unattended by the user. Applications with lower scores (e.g., applications with scores below the threshold) may be deprioritized. In examples, the lower scores indicate the applications that are less frequently used and/or more frequently left unattended by the user. Based on the combined scores for the applications, a prioritization mechanism sets a prioritization level for one or more of the applications. For instance, a first prioritization mechanism that is configured to reduce the latency and bandwidth consumption of low-priority applications may be used to deprioritize applications with lower scores, and a second prioritization mechanism that is configured to increase the latency and bandwidth consumption of high-priority applications are used to prioritize applications with higher scores. Alternatively, a single prioritization mechanism is used to prioritize and deprioritize applications. Prioritization manager 203, APM 102, and/or another component may implement the prioritization mechanisms. In some examples, prioritization manager 203 may be implemented as an application, in the OS, and/or in the kernel of system 200.

In some examples, APM 102 implements a smoothing heuristic to ensure that certain applications are not inappropriately prioritized or deprioritized. The smoothing heuristic implements one or more techniques to reduce erratic prioritization or deprioritization (e.g., prioritizing and deprioritizing an application in a short period of time). For example, APM 102 or prioritization manager 203 implements a grace period before prioritizing or deprioritizing an application unless an unattended threshold of scoring intervals or threshold of time is met for multiple scoring intervals. A scoring interval may be defined as the time between instances of generating a combined score for a given application by APM 102. In some other examples, APM 102 and/or prioritization manager 203 prioritizes or deprioritizes an application gradually. For example, APM 102 and/or prioritization manager 203 may increase or decrease the priority of the application in a stepwise manner, a logarithmic manner, a linear manner, or the like.

In some examples, APM 102 and/or prioritization manager 203 regenerates at least one of the individual factor scores and generate a new combined score for the application before (de) prioritizing the corresponding application. In some other examples, in addition or alternatively to periodic score updates by APM 102, APM 102 updates the combined scores for one or more applications when certain events occur. For instance, when an application is brought to the foreground by a user, APM 102 updates the combined score for the application (e.g., and boost the score by a certain amount, such as using the exponential decay approach by assigning higher scores to more recent score updates). In some other examples, APM 102 and/or prioritization manager 203 selectively prioritizes and/or deprioritizes one or more applications based on user input. For instance, APM 102 and/or prioritization manager 203 receives input (e.g., from a user) indicating that certain applications should be prioritized or deprioritized. For example, the user may manually configure an application's prioritization setting via a UI interface with APM 102 and/or prioritization manager 203. Alternatively, the input may indicate an application's intended frequency of use, usage scenario, expected resource expenditure during execution, or the like.

As one specific example of implementing a smoothing heuristic, APM 102 and/or prioritization manager 203 determine whether an application is unattended for a certain threshold of time (e.g., 10 minutes). If the application is unattended for the threshold of time, APM 102 and/or prioritization manager 203 determine whether the application has been unattended for a predetermined number (e.g., two, five, ten) of consecutive scoring intervals. If the application has been unattended for the predetermined number of consecutive scoring intervals, APM 102 and/or prioritization manager 203 deprioritizes the application. After the application has been deprioritized, APM 102 and/or prioritization manager 203 determines whether the application continues to remain unattended over one or more subsequent consecutive scoring intervals. If the application remains unattended for the subsequent consecutive scoring intervals, APM 102 and/or prioritization manager 203 applies a prioritization mechanism to the application by gradually lowering the priority of the application (e.g., in a stepwise fashion from high to medium to low). If the application subsequently becomes active or moved to the foreground, APM 102 and/or prioritization manager 203 may update the priority of the application (e.g., increase the priority of the application relative to the other applications). Accordingly, the smoothing heuristic improves the user experience by reducing the probability of deprioritizing an application that is active or important to the user (e.g., currently being used by the user, currently executing a task requested by the user, or currently being displayed to the user). The smoothing heuristic may also reduce the computational resource overhead by avoiding frequent and erratic prioritizing and/or deprioritizing.

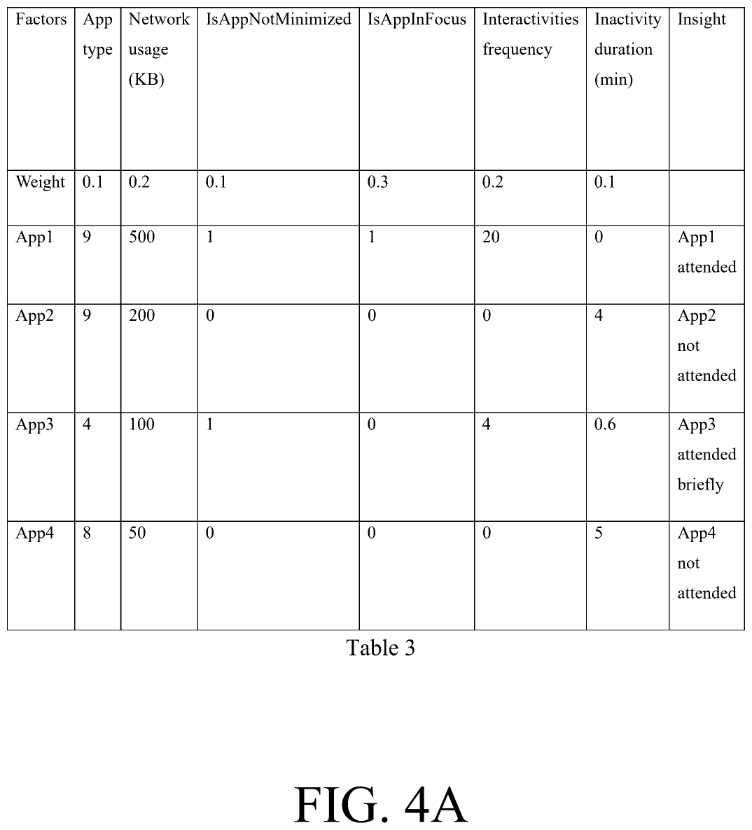

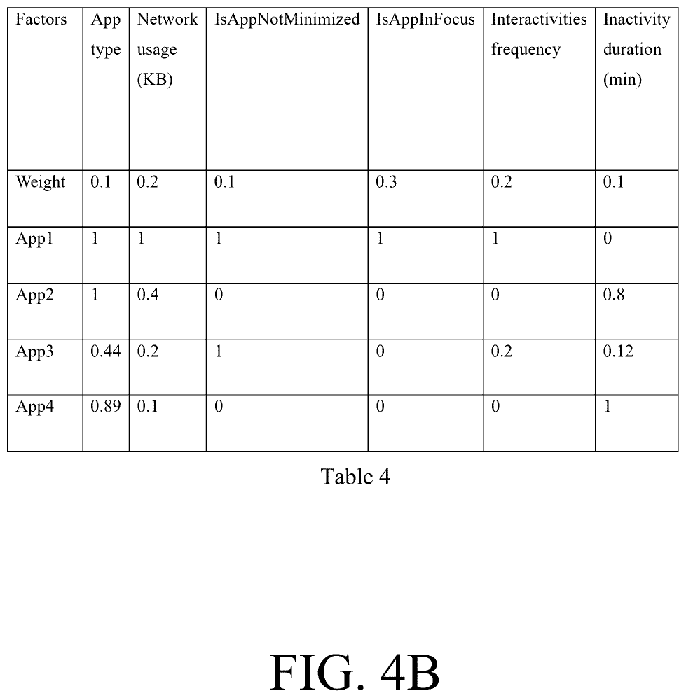

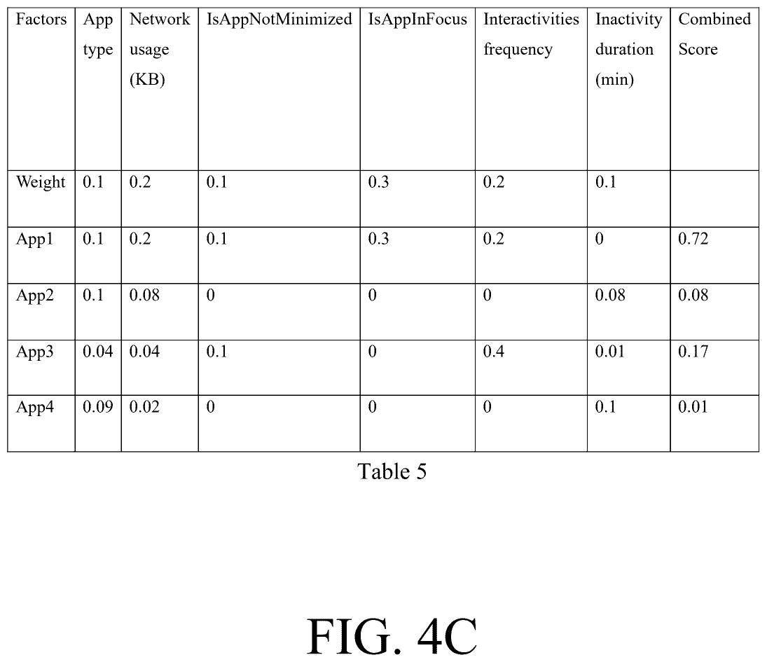

An example implementation of APM 102 is presented in Table 2 of FIG. 4A. Table 2 shows an example of statistics collected by APM 102 for four applications (e.g., Application 1 (App1), Application 2 (App2), Application 3 (App3), and Application 4 (App4)) at a given point in time. The values in the rows for each of the applications are the factor values. Some factor values (e.g., application type) may be determined using multiple signal values, as described previously. The values in the row for the weights are the weights applied to each factor. The factors shown (e.g., App type, network usage, IsAppNotMinimized, IsAppInFocus, Interactivities Frequency, Inactivity Duration) are example factors. App type indicates the application type of a given application, ranked from 1 to 9, where higher application types contribute more to the combined score for the application. Network usage represents a data usage amount (e.g., in KB) for a given application. IsAppNotMinimized indicates whether a given application is minimized. IsAppInFocus indicates whether an application is in focus on a screen. Interactivities frequency indicates a number of times that a given application has been interacted with over a given period of time. Inactivity Duration indicates the length of time (e.g., in minutes) a given application has been inactive or not in use by a user. The insights column indicates whether a given application is attended, which may be based on one or more of the factors in the table.

In FIG. 4B, Table 3 shows the statistics of Table 2 (for App1, App2, App3, and App4) as normalized values. As shown in Table 3, APM 102 normalizes the factor values between a number range (e.g., 0 and 1). APM 102 may divide each factor value by the maximum factor value among the applications for that factor. For example, if the maximum factor value for the network usage is 500 KB (e.g., as for App1), then the values for the network usage factor for each application will be divided by 500 to get normalized factor values. For instance, the value 500 for App1 is divided by 500 (e.g., 500/500=1.0), the value 200 for App2 is divided by 500 (e.g., 200/500=0.4), the value 100 for App3 is divided by 500 (e.g., 100/500=0.2), and the value 50 for App4 is divided by 500 (e.g., 50/500=0.1).

In FIG. 4C, Table 4 shows the statistics of Table 4 (for App1, App2, App3, and App4) as weight-adjusted values. As shown in Table 4, APM 102 multiplies each normalized factor value with the corresponding weight for the factor to achieve factor scores for each application. For instance, the value 1.0 for the network usage factor for App1 is multiplied by the weight 0.2 for the network usage factor (e.g., 1.0*0.2=0.2), the value 0.4 for the network usage factor for App2 is multiplied by the weight 0.2 for the network usage factor (e.g., 0.4*0.2=0.08),) the value 0.2 for the network usage factor for App3 is multiplied by the weight 0.2 for the network usage factor (e.g., 0.2*0.2=0.04), and the value 0.1 for the network usage factor for App4 is multiplied by the weight 0.2 for the network usage factor (e.g., 0.1*0.2=0.02).

To compute a combined score for a given application, APM 102 combines (e.g., using addition, subtraction, and/or any other mathematical operation) the factor scores in the row for the given application. For example, in computing the factor score for App1, APM 102 adds the factor scores for app type, network usage, IsAppNotMinimized, IsAppInFocus, and Interactivities Frequency (i.e., 0.1+0.2+0.1+0.3+0.2=0.9). In some examples, APM 102 subtracts the factor score for Inactivity Duration from the computed factor score (i.e., 0.9−0.1=0.8), as a higher factor score for the Inactivity Duration factor decreases the priority of an application, whereas a high factor score for the other factors (e.g., app type, network usage, IsAppNotMinimized, IsAppInFocus, and Interactivities Frequency) increases the priority of an application.

In some examples, APM 102 applies an exponential decay factor (e.g., 0.8 in this example) to a past combined score to account for the temporal changes in application priority. For example, APM 102 multiplies the combination of the factor scores by the exponential decay factor to produce the combined score. For example, a currently calculated combined score may be multiplied by 0.2 and a past combined score may be multiplied by 0.8, and the two values may be added. For example, if current combined score is 0.4, and a past combined score is 0.1, exponential decay may be applied such that a final score of 0.16 is calculate (e.g., (0.8*0.1)+ (0.2*0.4)=0.16). More weight is given to the past score than the current score in this example.

In some examples, based on the combined scores, APM 102 (or another component such as prioritization manager 203) ranks the applications to determine relative application priority. For example, application 1 is ranked as highest priority because it has the highest combined score, application 3 is ranked as second highest priority, and so on. APM 102 or prioritization manager 203 can apply different prioritization mechanisms to the apps based on their priority. For example, APM 102 assigns application 4 to a prioritization manager 203 that performs application deprioritization (e.g., LEDBAT) based on application 4 having the lowest combined score, and assign application 1 to a prioritization manager 203 that performs application prioritization (e.g., a QoS manager) based on application 1 having the highest combined score. In some examples, APM 102 or prioritization manager 203 may adjust the application settings to increase the quality of high priority applications or decrease the quality of low priority applications, and vice versa. In some examples, APM 102 or prioritization manager 203 may stop tracking applications that have been inactive for threshold period of time or have a priority below a threshold level a period of time.

In some other examples, APM 102 compares the combined scores for each application with one or more predetermined threshold scores to determine priority levels (e.g., high, medium high, medium, medium low, low) for the applications. For example, if the threshold score for high priority is 0.7, then application 1 is considered high priority and applications 2-4 are not considered high priority. APM 102 or prioritization manager 203 applies QoS to prioritize system and/or network resources for application 1. If the threshold score for low priority is 0.1, applications 2 and 4 are considered low priority. Accordingly, APM 102 applies a prioritization manager 203 that performs application deprioritization to applications 2 and 4. As application 3 is not considered high or low priority, APM 102 does not cause a change to the current priority of application 3. In some examples, APM 102 compares inactivity durations for each application with a predetermined inactivity threshold to determine whether applications are active or inactive. In some examples, APM 102 stops tracking inactive applications having a combined score below a certain threshold (e.g., the low priority threshold or a different threshold), or if the inactivity duration exceeds a threshold period of time.

State repository 103 is a service that manages and/or stores application information, property information, and state information for applications (e.g., packaged applications). For example, state repository 103 manages and/or stores package related metadata, application manifest metadata, user information, binary executable information, package policy information, and/or activation entry points. In some examples, state repository 103 provides an API that allows for querying this information at runtime. The application information is received from one or more services implemented by and/or accessible to system 100. State repository 103 provides the application information as signal values to APM 102. State repository 103 stores and updates the information about, for example, each application's package type (e.g., native package managers, general purpose application packages), package origin, and application category, which are used by APM 102 to determine the application's priority level and/or prioritization mechanism.

State repository 103 provides the application metadata to APM 102 upon request. For example, when APM 102 receives a notification from an application driver indicating that the application is requesting networking resources, APM 102 queries state repository 103 for the application's package type, package origin, and app category. Based on this information, APM 102 determines a priority level and/or a prioritization mechanism for the application. The priority level and the prioritization mechanism affect the processing resources, bandwidth allocation, latency, packet loss, and/or QoS associated with allocated resources of the application.

State repository 103 updates the information about the application's data usage, network statistics, and the like, which are collected from other system services. For example, APM 102 periodically provides the application's network statistics (e.g., the amount of data sent and received, number of active and inactive network sessions, network latency, packet loss rate, QoS) to state repository 103. State repository 103 then updates its database with the new information, which can be used for further analysis and optimization of the network traffic management. State repository 103 also provides the information about the application's network activity to APM 102 upon request, which enables APM 102 to adjust the priority and traffic policy of the application according to the current network conditions and the application's behavior.

Network layer services 104 (e.g., L2 services) provide network quality or context information, among other information, as signal values to APM 102. Network layer services 104 are lower layer network services (e.g., Wi-Fi service or cellular service) that are responsible for establishing and maintaining the network connection. Network layer services 104 monitors the lower layer network services for network events, such as the network connection change, the network signal change, the network bandwidth change, and the network type change. Network layer services 104 then interacts with the lower layer network services to obtain information about network characteristics, such as the service set identifier (SSID), the signal strength, the maximum bandwidth, and/or the network type of the current network connection. Network layer services 104 updates itself using the information about the network characteristics. Network layer services 104 also assigns a unique identifier to each network connection, which is used by the APM 102 to track the network quality or context. Network layer services 104 provides the information about the network quality or context to the APM 102, which enables APM 102 to increase the accuracy of decisions about the application's priority and traffic policy.

Broker infrastructure 105 tracks static and dynamic information of application processes, such as application state, lifetime, and interactivity. Broker infrastructure 105 provides notifications and APIs to enable other system services, such as APM 102 and/or state repository 103, to access and update the information of each application process. Broker infrastructure 105 may include a host activity manager (HAM). The HAM collects static and/or dynamic state information about packaged applications, such as whether a packaged application is in the foreground or background, the current state of a UI associated with the packaged application (e.g., whether the UI is minimized, maximized, hidden/concealed, obfuscated, not-in-focus), and interaction information for the UI associated with the packaged application (e.g., time of last interaction, details of the interaction, result of the interaction). A packaged application refers to a software bundle that includes an application and the necessary files (e.g., configuration files, dependencies, first application 108, second application 109) for installing and/or managing the application in a computing environment. The HAM provides this information to APM 102 as signal values for the information. For example, the HAM provides a signal value indicating NumberOfInteractivities including an integer value, a signal value providing NumberOfInactivities including an integer value, and/or a signal value indicating canShowUI including a Boolean value. NumberOfInteractivities indicates the number of times the user interacted with the application process, NumberOfInactivities indicates a number of inactive or idle periods for an application, and canShowUI indicate whether the application process can display a UI.

As described previously, broker infrastructure 105 tracks the static information of each application process, such as the application's package family name (PFN), host type for packaged applications, host ID for packaged applications, and/or process ID. This information is part of a state summary structure for a process, which is managed by broker infrastructure 105. Broker infrastructure 105 also tracks the dynamic information of each application process, such as interactivities with the UI, foreground-ness, and execution state. This information is obtained from various sources, such as the kernel layer as illustrated in FIG. 1. For example, broker infrastructure may obtain this information from a process scheduler, a memory manager, or an input/output (I/O) manager in the kernel layer. The process scheduler is a software component that manages the execution state of applications and determines which process runs in the foreground. The memory manager keeps track of the memory status of applications, which can be an indicator of the application's execution state. The I/O manager handles user interactions with the UI, such as keyboard and mouse inputs.

Broker infrastructure 105 provides notifications and APIs enabling other system services to access and update the information of each application process. For example, broker infrastructure 105 provides an API to register for application/package state change notifications, which enables other system services, such as APM 102, to receive notifications from broker infrastructure 105 whenever there is a change in the state summary structure of an application process. The notification payload includes the state summary structure of the application process to be evaluated. Broker infrastructure 105 provides an API to query the current state summary of an application process given its host ID, which enables other system services to poll the current information of an application process from broker infrastructure 105. The host ID can be extracted from the process ID or the process token of the application process.

Broker infrastructure 105 interacts with APM 102 in several ways. In some examples, broker infrastructure 105 notifies APM 102 of the state changes of application processes (e.g., its interactivity, its foreground-ness, and/or its execution state). Broker infrastructure 105 provides information as signal values for these metrics to APM 102. These state changes can serve as additional useful conditions for APM 102 or prioritization manager 203 to apply a prioritization mechanism. In some other examples, broker infrastructure 105 provides APM 102 with the information of application processes, such as its package type, its package origin, and its application category. This information enables APM 102 to determine the priority level of the application process.

SRUM 106 provides network usage information to APM 102. SRUM 106 tracks the resource consumption (e.g., such as CPU, memory, disk, and network resources) of applications and processes of system 100 and provides the resource consumption to APM 102. For network usage, SRUM 106 provides network information for applications (e.g., bytes sent and received, protocol and port used) to APM 102. The bytes sent and received indicate the amount of data that an application or process transfers over the network. In examples, APM 102 registers with SRUM 106 to track real-time network data usage for a user. For example, APM 102 may subscribe to receive notifications from SRUM 106 when the network usage of the applications or processes changes, and APM 102 may receive the notifications as signal values from SRUM 106.

NSI 107 provides information including network properties, network states, and other network interface signals (e.g., network adapter media type, network adapter link speed, number of connections) to APM 102. In some examples, NSI 107 includes an IP Helper service, which provides services that enable the retrieval and modification of network configuration settings for system 100. NSI 107 collects various data related to the network hardware and the logical network interfaces that are created by the network hardware. A logical network interface is a virtual representation of a network connection that can serve different purposes, such as connecting to the internet, a local device, or a specific service. For example, a Wi-Fi adapter can create a first logical network interfaces for connecting to the internet and a second logical interface for connecting to a Wi-Fi direct device, such as a monitor in a meeting room. NSI 107 maintains rich metadata of the network adapters and interfaces, such as their properties, states, signals, and statistics. In some examples, APM 102 queries NSI 107 for the network properties, states, signals, and/or statistics of the network adapters and interfaces that are relevant to the applications that APM 102 manages.

First application 108 provides information to OS brokers 121. For example, first application 108 provides information intended for network transmission via TCP/IP driver 119/NIC 112 to another component, system, or device. The information intended for network transmission may include text message information, file information, streaming information, game information, sensor information, API request information, update information, and/or authentication information. First application 108 represents one or more applications of a first type or configured for a first particular design philosophy. For instance, first application 108 may be configured to focus on security and stability (in lieu of performance) using a sandboxed environment to protect system 100 from potential harm caused by the application 108. First application 108 may have a package identity, which is a unique identifier that consists of, for example, the app name, publisher, version, and architecture. Package identity is used to verify the app's authenticity and integrity, and to enforce the app's capabilities and declarations.

Similarly to first application 108, second application 109 provides information to OS brokers 121, where the information is intended for network transmission via TCP/IP driver 119/NIC 112 to another system or device. The information intended for network transmission may include those types of information discussed with respect to first application 108, such as text message information, file information, streaming information, etc. Second application 109 represents one or more applications of a second type or configured for a second particular design philosophy. For instance, second application 109 may be configured to focus on compatibility, flexibility, and performance (in lieu of security and stability), and enable a wide variety of tasks, including low-level system operations. In some examples, second application 109 does not have a package identity. In some examples, application 108 and application 109 may be different or the same application types (e.g., models or frameworks for applications).

Kernel callout 111 intercepts and processes network traffic at the kernel level and provides information to connection management service RPC 122 through asynchronous calls. Kernel callout 111 registers callbacks for various network events at the transport layer (L4 116) of the network stack, such as ALE resource assignment 113, ALE flow established 114, and ALE endpoint closure 115.

Kernel callout 111 communicates with connection management service RPC 122, which is a component that provides remote procedure calls to connection management service 101. Kernel callout 111 uses the asynchronous calls to inform connection management service RPC 122 about network events that impact applications, such as the allocation and release of network resources, the establishment and termination of network flows, and/or changes in network conditions. APM 102 monitors connection management service RPC 122 during communication (e.g., until endpoint closure) to enable the collection of network metrics and statistics by APM 102. In some examples, kernel callout 111 enforces a network privacy policy through its implementations of the ALE layers.

NIC 112 represents a network interface card (e.g., a physical or a virtual network interface card) that connects system 100 to a network and interacts with TCP/IP driver 119 through one or more drivers. The drivers are software components that translate generic network stack commands into device-specific operations and provide an interface between the network stack and NIC 112. Drivers implement the functions and protocols required for network communication and manage the initialization, configuration, and management of NIC 112. NIC 112 enables system 100 to send and receive data over a wired and/or wireless network. NIC 112 has an address (e.g., a media access control (MAC) address) which identifies system 100 on a local network segment.

NIC 112 and TCP/IP driver 119 work together to facilitate network communication for the device. NIC 112 converts the data from TCP/IP driver 119 into electrical signals or radio waves, transmitting them over a network medium (e.g., wire, fiber, air). NIC 112 receives signals or waves from the network medium, converting them back into data for TCP/IP driver 119. TCP/IP driver 119 processes this data and interfaces with higher-level network protocols and services, enabling communication between applications and the network.

In some instances, a set of kernel-mode layers (e.g., ALE) within a filtering platform are used for stateful filtering. This type of filtering monitors the state of network connections and permits packets that correspond to a recognized connection state. For instance, stateful filtering for a TCP connection starting from a protected network area may permit incoming packets that are consistent with previously sent outgoing packets. Within these layers, filters (e.g., ALE resource assignment 113, ALE flow established 114, and/or ALE endpoint closure 115) are responsible for authorizing the creation of inbound and outbound connections, assigning ports, and managing socket operations such as initiating a listening state, creating raw sockets, and receiving in promiscuous mode. These layers allow network traffic to be filtered according to the identity of the application, e.g., using a generalized file name, and/or the identity of the user, employing a security descriptor. An example of policy enforcement at these layers may be to permit a messaging application complete network access while restricting all other applications. In such a scenario, when the messaging application initiates a network connection, the event is captured, the initiating application is identified, and a query is made to the filtering engine to decide if the connection should be allowed.

ALE resource assignment 113 is a part of kernel callout 111 and is a layer that assigns network resources to applications (e.g., first application 108 and/or second application 109) based on their package identity and/or priority. Priority is a value that indicates the relative importance of the app's network traffic, and can be set by the user or system 100 (e.g., APM 102, prioritization manager 203, or a prioritization mechanism implemented by APM 102/prioritization manager 203). In some examples, the priority for a given application may be set by APM 102, prioritization manager 203, or a prioritization mechanism implemented by APM 102/prioritization manager 203. In some examples, ALE resource assignment 113 assigns network resources to applications by using information from APM 102 and/or prioritization manager 203. ALE resource assignment 113 notifies APM 102 (e.g., via an RPC call to connection management service RPC 122) of any changes in the network resources of the applications, and may receive updates or feedback from APM 102.

ALE flow established 114 is a part of kernel callout 111 and is a layer that establishes network flows for applications (e.g., first application 108 and/or second application 109) and monitors their state and activity. A network flow is a sequence of packets that share the same source and destination addresses, ports, and protocols. A network flow represents a logical connection between two endpoints, such as an app and a server. ALE flow established 114 creates a network flow for each application that requests network access, and assigns it the appropriate network resources. ALE flow established 114 monitors the state and activity of network flows for the applications by using the information from TCP/IP driver 119. TCP/IP driver 119 includes L4 116, L3 117, and L2 118, which are layers of the network stack that handle transport, network, and data link functions, respectively. ALE flow established 114 tracks the status of network flows (e.g., active, idle, or closed) and the amount of data transferred (e.g., bytes sent and received). ALE flow established 114 also detects any changes in network conditions (e.g., congestion, loss, or delay) and adjusts the network resources of network flows accordingly. ALE flow established 114 may notify APM 102 via an RPC call to connection management service RPC 122 of any relevant changes in the network flows of the applications.

ALE endpoint closure 115 is a part of kernel callout 111 and is a layer that closes network flows for applications (e.g., first application 108 and/or second application 109) and releases the network resources associated with the applications. ALE endpoint closure 115 detects when a network flow is no longer needed or valid, such as when the application terminates, data transfer to and/or from the application is complete, the user closes the application, the network connection is lost, and/or the network policy changes. In some examples, ALE endpoint closure 115 closes the network flow and informs the transport layer (L4 116) of the network stack. ALE endpoint closure 115 releases the network resources associated with network flows for the applications. ALE endpoint closure 115 frees the network resources that were allocated to the network flow, and makes them available for other network flows or applications. In some examples, ALE endpoint closure 115 notifies APM 102 of the freed network resources (e.g., via an RPC call to connection management service RPC 122).

L4 116 is the transport layer of the network stack. L4 116 supports one or more transport protocols (e.g., TCP and/or user datagram protocol (UDP)). The information provided from first application 108 and/or second application 109 is segmented and wrapped with a transport layer header comprising port numbers for the sending and receiving applications. L4 116 provides the information to L3 117. L4 116 communicates with WFP ALE resource assignment 123, WFP ALE flow established 124, and/or WFP ALE endpoint closure 110.

WFP ALE resource assignment 123 assigns ports for applications communicating over a network. WFP ALE resource assignment 123 informs ALE resource assignment 113 of the assigned ports. WFP ALE flow established 124 communicates with the ALE flow established 114 to signal that a network flow has been successfully created and is now established. ALE endpoint closure 115 in kernel callout 111 communicates with the WFP ALE endpoint closure 110 to manage the closure of a network flow or connection. For example, ALE endpoint closure 115 signals WFP ALE endpoint closure 110 to indicate that a network flow or connection is being closed. This ensures that resources are released and the network stack is updated to reflect the end of the connection.

L3 117 is a network layer of the network stack. L3 117 supports one or more protocols (e.g., IP and/or internet control message protocol (ICMP)). L4 116 provides the information from first application 108 and/or second application 109 to L3 117. L3 117 adds the IP header to the information, including the source and destination IP addresses, to create a packet. L3 117 uses the IP protocol to assign a unique address to each device on the network, and/or to deliver the information based on the source and destination addresses. In some examples, L3 117 uses the ICMP protocol, which is a protocol that provides error and diagnostic messages, such as ping and traceroute.

L2 118 is a data link layer of the network stack. L2 118 supports one or more protocols (e.g., Ethernet and/or address resolution protocol (ARP)). L3 117 provides the information to L2 118, which frames the packet by adding the MAC addresses of the source and destination NICs. L2 118 handles physical transmission and reception of information over the network medium. In some examples, L2 118 uses the Ethernet protocol to define the format and structure of the data frames and the rules for accessing the network medium. In some examples, L2 118 uses the ARP protocol, which is a protocol that resolves the IP address of a device to its MAC address (e.g., the address of NIC 112).

TCP/IP driver 119 is a kernel-mode network stack that implements the TCP/IP protocol suite. TCP/IP driver 119 interfaces with a kernel-level network stack and interfaces with NIC 112 to handle network traffic at the L2 (Data Link) 118, L3 (Network) 117, and L4 (Transport) 116 layers and handle communication between network devices and applications. TCP/IP driver 119 supports the TCP/IP protocol suite, which is the standard set of protocols for the Internet and other networks. TCP/IP driver 119 receives (e.g., via OS brokers 121) information from first application 108 and/or second application 109.

System process 120 is executed software program that monitors application events. In examples, system process 120 monitors application process states, gathers metadata, and assesses user interactivity. For instance, system process 120 may track when a user switches between applications or when an application is minimized. System process 120 provides this information to APM 102 as signal values. APM 102 then generates scores based on the provided information.

OS brokers 121 facilitates the communication between applications (e.g., first application 108 and/or second application 109) and TCP/IP driver 119. The information that the applications provide to OS brokers 121 includes the package identity of the application, the type of event that occurred, the time and date of the event, and/or any additional data that is relevant to the event. For example, if an application is launched, the information that the application provides to OS brokers 121 may include the name and version of the application, the device and user that launched the application, the launch mode and arguments, and the memory and CPU usage of the application.

OS brokers 121 handles network transfers on behalf of applications providing the information provided by the applications to TCP/IP driver 119. In some examples, OS brokers 121 enables applications to perform background transfers, such as downloading or uploading files, e.g., without requiring the user's attention or interaction. In some examples, OS brokers 121 supports features such as resumable transfers, bandwidth throttling, and transfer priority. In some examples, first application 108 and/or second application 109 may make direct networking calls to TCP/IP driver 119 rather than using an intermediate broker service such as OS brokers 121.

FIG. 2 illustrates an example system diagram that implements an application prioritization manager and a resource allocation manager for assigning priorities to applications. System 200 includes application 201, application 202, APM 102, and prioritization manager 203. In some examples, applications 201 and/or 202 may be implementations of first application 108 and/or second application 109. Application 201 and/or application 202 provide information to APM 102, such as their process state, metadata, interactivity, network usage, and connection metrics. APM 102 collects information from applications 201 and/or 202 via one or more components (e.g., state repository 103, network layer services 104 broker infrastructure 105, SRUM 106, NSI 107, kernel callout 111, NIC 112, and/or system process 120).

APM 102 uses the collected information to generate scores for various factors that affect the user experience and/or network performance of each application. APM 102 combines the scores for the different factors into a combined score for each application, and provides the combined scores to prioritization manager 203. Additionally or alternatively, APM 102 provides a prioritization indication (e.g., a ranking of the application among the plurality of applications or a prioritization descriptor for the application, such as “High”, “Low”, “Medium”) for the different applications to prioritization manager 203 based on the combined scores for the applications.

Prioritization manager 203 ranks the applications based on their combined scores, and selects a prioritization mechanism for each application. A prioritization mechanism is a software component, algorithm, or a device that determines network resources allocation to different applications or traffic flows. For example, prioritization manager 203 applies LEDBAT, QOS, or other mechanisms to allocate network resources for the applications. Prioritization manager 203 may adjust the prioritization mechanism dynamically based on changing network conditions (e.g., based on receiving updated combined scores from APM 102).

Prioritization manager 203 uses different approaches to select a prioritization mechanism based on the scores and/or rankings for the applications 201 and 202. For example, the prioritization manager 203 may use a threshold-based approach to assign a first prioritization mechanism (e.g., QoS) to an application that has a combined score above or equal to a threshold score, and a second prioritization mechanism (e.g., LEDBAT) to an application that has a combined score below the threshold score. In some examples, prioritization manager 203 may use a multiple threshold-based approach. For instance, prioritization manager 203 assigns a first prioritization mechanism (e.g., QoS) to an application that has a combined score above or equal to a first threshold score, assigns a second prioritization mechanism (e.g., LEDBAT) to an application that has a combined score below a second threshold score (that is lower that the first threshold score), and assign a third prioritization mechanism to an application that has a combined score between the first and second threshold scores.

Alternatively, prioritization manager 203 uses a ranking-based approach, where prioritization manager 203 assigns different prioritization mechanisms to different ranks of the applications. For example, the prioritization manager 203 assigns a first prioritization mechanism (e.g., QoS) to the top 10% of applications, a second prioritization mechanism (e.g., LEDBAT) to the bottom 50% of applications, and a third prioritization mechanism to the middle 40% of applications.

In some examples, prioritization manager 203 uses a machine learning or AI-based approach that uses a trained ML model to determine a prioritization mechanism for each application based on a combined score for the application, network usage patterns, and/or previous application prioritization decisions. Other factors to be considered by the ML model include historical performance metrics, real-time system load, user behavior patterns, QoS requirements, application type, time of day, network conditions, service level agreements, cost of resources, energy consumption, priority levels, predictive analysis, resource utilization trends, inter-application dependencies, and compliance and/or security constraints.

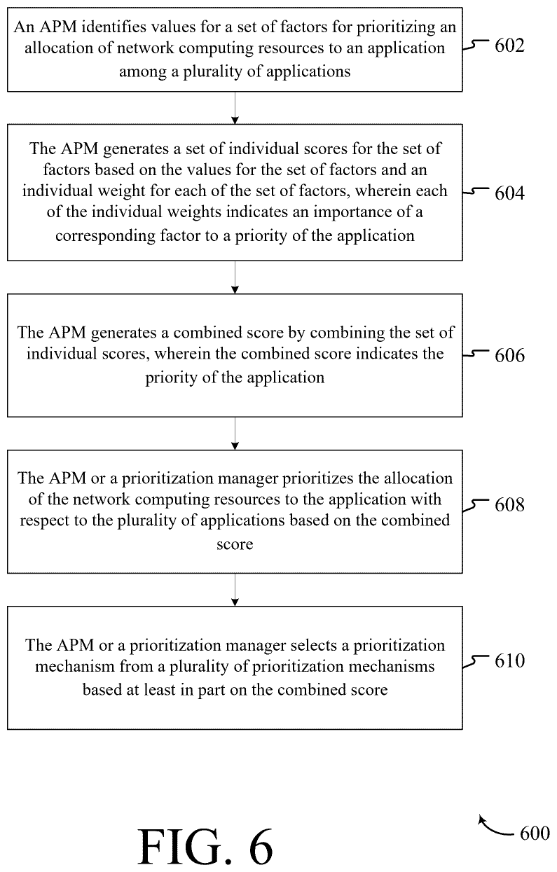

FIG. 6 illustrates an example method for selecting a prioritization manager to perform prioritization for an application. The method 600 may be performed by the systems described herein and/or the components of such systems. For instance, the method 600 may be performed by APM 102 and/or prioritization manager 203, among other components.

At operation 602, APM 102 identifies values for a set of factors for prioritizing an allocation of network computing resources to an application (e.g., application 201) among a plurality of applications. The factors include, for example, application type, application network usage, whether an application is minimized, whether an application is in focus, or substantially any other factor related to the performance or user experience of the first application. The values of the factors are derived from signal values received from various components of the system 100, such as state repository 103, network layer services 104, broker infrastructure 105, SRUM 106, and/or NSI 107.

At operation 604, APM 102 generates a set of individual scores for the set of factors based on the values for the set of factors and an individual weight for each of the set of factors, where each of the individual weights indicates an importance of a corresponding factor to a priority of the application. The individual scores reflect the contribution of each factor to the overall priority level of the first application. The individual weights are determined in various ways, such as using ML-based models, user preferences, or predefined configurations.

At operation 606, APM 102 generates a combined score by combining the set of individual scores, where the combined score indicates the priority for the application. The combined score represents the aggregate effect of the factors on the first application's network resource allocation. The combined score may be calculated using various methods, such as arithmetic mean, weighted mean, geometric mean, or harmonic mean.

At operation 608, APM 102 or prioritization manager 203 prioritizes the allocation of the network computing resources to the application with respect to the plurality of applications based on the combined score. Alternatively, APM 102 provides the combined score or an indication associated with the combined score to prioritization manager 203. Prioritization manager 203 then prioritizes the first application among the plurality of applications based on the combined score or the indication of the combined score. In examples, prioritizing the first application involves selecting a prioritization mechanism, such as LEDBAT or QoS, and assigning the first application to the prioritization mechanisms. In examples, a prioritization mechanism is selected based on the combined score or the indication. For instance, a combined score indicating that the first application should be prioritized may cause a first prioritization mechanism to be selected, where a combined score indicating that the first application should be deprioritized may cause a second prioritization mechanism to be selected. The prioritization mechanisms then adjust the network resources allocated to the first application based on the priority of the first application. For instance, a prioritization mechanism may increase the available bandwidth and/or throughput for network traffic of the first application. Alternatively, the prioritization mechanism increases the buffer space in routers or switches for network traffic of the first application, and causes one or more files or devices in a network to the be accessible to the first application.

At operation 610, APM 102 or prioritization manager 203 selects a prioritization mechanism from a plurality of prioritization mechanisms based at least in part on the combined score. The prioritization mechanisms include, for example, LEDBAT or QoS. The selected prioritization mechanism then prioritizes the application in accordance with the application's determined priority (e.g., determined by APM 102). For instance, the prioritization mechanism causes a first application to be prioritized over one or more other applications. In examples, prioritizing an application causes system and/or network resources to be allocated to or prioritized for use by the prioritized application. For instance, the system executing the prioritized application allocates additional bandwidth and/or CPU to the prioritized application. In such an instance, the system executing the prioritized application deallocates the bandwidth and/or CPU from one or more other applications in order to provide the bandwidth and/or CPU to the prioritized application. Alternatively, the system executing the prioritized application requests that additional bandwidth and/or CPU be allocated to the system (e.g., by instantiating a virtual machine (VM) instance or other virtualized and/or physical resources). The system may then allocate the additional bandwidth and/or CPU be allocated to the system to the prioritized application to prevent the one or more other applications being executed by the system from being negatively impacted due to resource (bandwidth and/or CPU) deallocation.

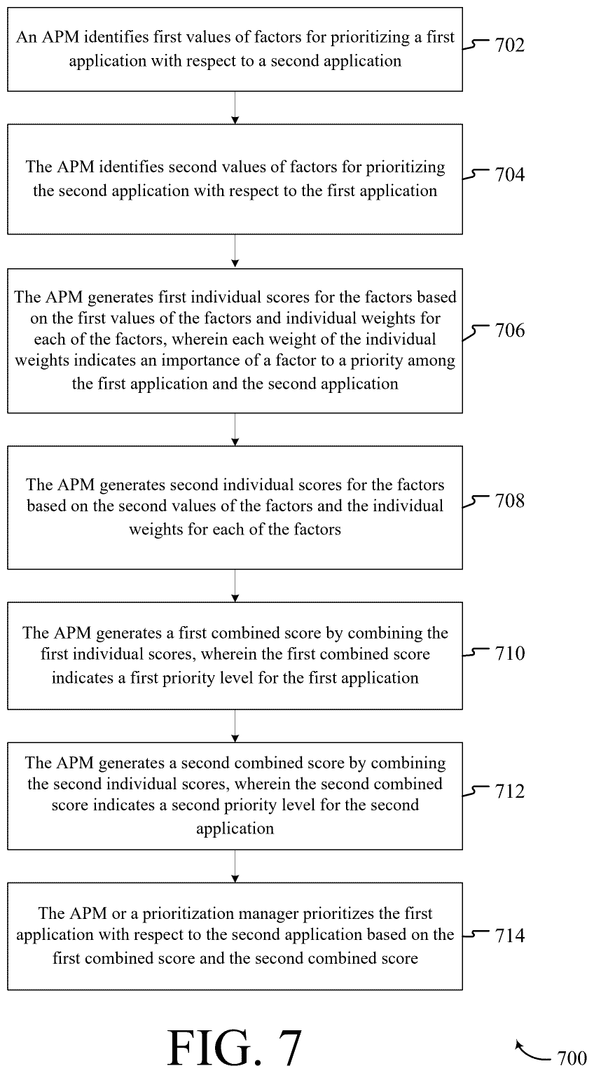

FIG. 7 illustrates an example method for prioritizing an application among one or more other applications. The method 700 may be performed by the systems described herein and/or the components of such systems. For instance, the method 700 may be performed by APM 102, and/or prioritization manager 203, among other components.

At operation 702, APM 102 identifies first values of factors for prioritizing a first application (e.g., first application 201) with respect to a second application (e.g., second application 202). The factors include, for example, application type, application network usage, whether an application is minimized, whether an application is in focus, or substantially any other factor related to the performance or user experience of the application. The first values of the factors are derived from signal values received from various components of the system 100, such as state repository 103, network layer services 104, broker infrastructure 105, SRUM 106, NSI 107, or other components.

At operation 704, APM 102 identifies second values of factors for prioritizing the second application with respect to the first application. The second values of the factors are derived from the same or different components as the first values of the factors.

At operation 706, APM 102 generates first individual scores for the factors based on the first values of the factors and individual weights for each of the factors, wherein each weight of the individual weights indicates an importance of a factor to a priority among the first application and the second application. The first individual scores reflect the contribution of each factor to the overall priority level of the first application. The individual weights are determined in various ways, such as using ML-based models, user preferences, or predefined configurations.

At operation 708, APM 102 generates second individual scores for the factors based on the second values of the factors and the individual weights for each of the factors. The second individual scores reflect the contribution of each factor to the overall priority level of the second application.

At operation 710, APM 102 generates a first combined score by combining the first individual scores, wherein the first combined score indicates a first priority level for the first application. The first combined score represents the aggregate effect of the factors on the first application's network resource allocation. The first combined score may be calculated using various methods, such as arithmetic mean, weighted mean, geometric mean, or harmonic mean.

At operation 712, APM 102 generates a second combined score by combining the second individual scores, wherein the second combined score indicates a second priority level for the second application. The second combined score represents the aggregate effect of the factors on the second application's network resource allocation. The second combined score may be calculated using the same or different methods as the first combined score.

At operation 714, APM 102 or prioritization manager 203 prioritizes the first application with respect to the second application based on the first combined score and the second combined score. The prioritization may involve assigning the first application and the second application to the same or different prioritization mechanisms, such as LEDBAT or QoS.

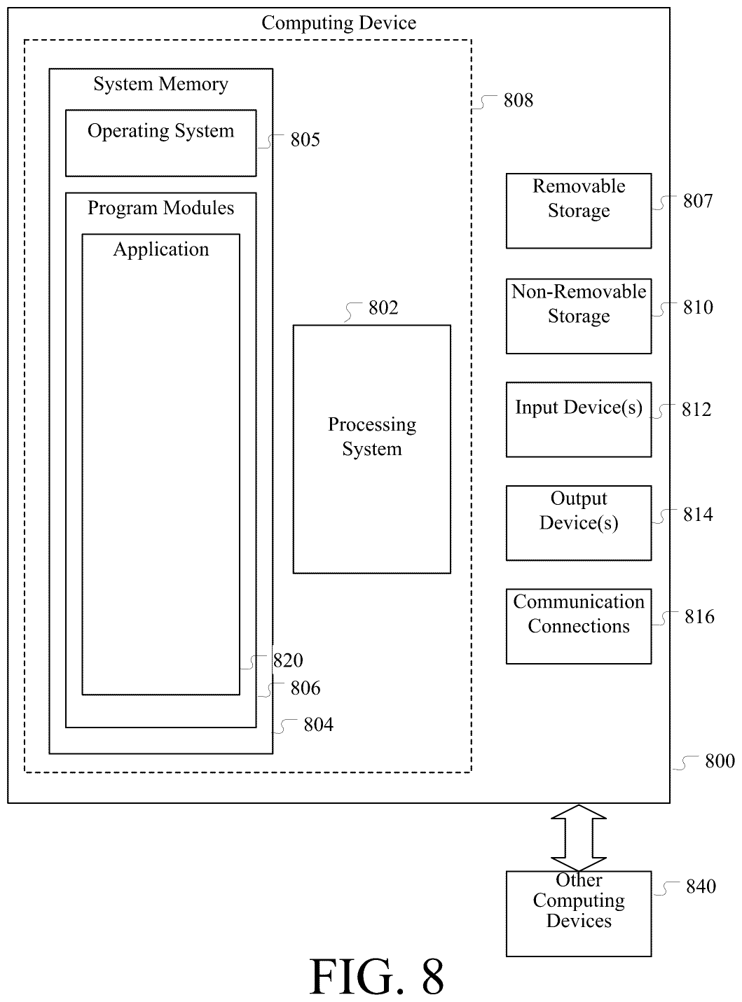

FIG. 8 is a block diagram illustrating physical components (e.g., hardware) of a computing device 800 with which aspects of the disclosure may be practiced. The computing device components described below may be suitable for the computing devices and systems described above. In a basic configuration, the computing device 800 includes at least one processing system 802 comprising processing unit(s) and a system memory 804. Depending on the configuration and type of computing device, the system memory 804 may comprise volatile storage (e.g., random access memory (RAM)), non-volatile storage (e.g., read-only memory (ROM)), flash memory, or any combination of such memories.

The system memory 804 includes an operating system 805 and one or more program modules 806 suitable for running software application 820, such as one or more components supported by the systems described herein. The operating system 805, for example, may be suitable for controlling the operation of the computing device 800.

Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, or optical disks. Such additional storage is illustrated in FIG. 8 by a removable storage device 807 and a non-removable storage device 810.

As stated above, a number of program modules and data files are stored in the system memory 804. While executing on the processing system 802, the program modules 806 (e.g., application 820) performs processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 840. Examples of suitable communication connections 816 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 807, and the non-removable storage device 810 are all computer storage media examples (e.g., memory storage). Computer storage media may include RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As will be understood from the present disclosure, one example of the technology discussed herein relates to a system comprising: a processor; and memory comprising executable instructions that when executed, perform operations comprising: identifying values for a set of factors for prioritizing an allocation of network computing resources to an application among a plurality of applications; generating a set of individual scores for the set of factors based on the values for the set of factors and an individual weight for each of the set of factors, wherein each of the individual weights indicates an importance of a corresponding factor to a priority of the application; generating a combined score by combining the set of individual scores, wherein the combined score indicates the priority of the application; and prioritizing the allocation of the network computing resources to the application with respect to the plurality of applications based on the combined score.

In some examples, the values for the set of factors are based at least in part on a set of signal values.

In some examples, the operations further comprise: generating the individual weights using an ML model.

In some examples, the operations further comprise: normalizing each of the set of individual scores for the set of factors.

In some examples, the operations further comprise: providing a prioritization indication for the application based at least in part on the combined score.

In some examples, the prioritization indication comprises at least one of: the combined score, a ranking of the application among the plurality of applications, or a prioritization descriptor for the application.

In some examples, the set of factors comprises at least one of: an application type, application network data usage, an application inactivity duration, or an application interactive frequency.

In some examples, the operations further comprise applying a decay factor to at least one individual score of the set of individual scores.

In some examples, the operations further comprise deprioritizing the application after a grace period.

In some examples, the operations further comprise deprioritizing the application gradually over a time period.

In some examples, the operations further comprise re-generating at least one individual score of the set of individual scores before deprioritizing the application.

In some examples, combining the set of individual scores comprises at least one of adding or subtracting at least two individual scores of the set of individual scores.

Another example of the technology discussed herein relates to a system comprising: a processor; and memory comprising executable instructions that when executed, perform operations comprising: identifying values of a set of factors for prioritizing an application among a plurality of applications; generating a set of individual scores for the set of factors based on values of the set of factors and individual weights for each of the set of factors, wherein each of the individual weights indicates importance of the factor to a priority for the application; generating a combined score by combining the set of individual scores, wherein the combined score indicates the priority for the application; and selecting a prioritization mechanism from a plurality of prioritization mechanisms based at least in part on the combined score.

In some examples, the selecting comprises selecting a first prioritization mechanism from the plurality of prioritization mechanisms based at least in part on the combined score being above a first threshold score, or selecting a second prioritization mechanism from the plurality of prioritization mechanisms based at least in part on the combined score being below the first threshold score.

In some examples, the operations further comprise setting a QoS priority for the application based at least in part on the combined score.

In some examples, the factors comprise at least one of application network usage metrics, application metadata, an application priority level, application dependencies, application system resource usage, user context and behavior, a network type, or historical data.

Another example of the technology discussed herein relates to a method comprising: identifying first values of factors for prioritizing a first application with respect to a second application; identifying second values of factors for prioritizing the second application with respect to the first application; generating first individual scores for the factors based on the first values of the factors and individual weights for each of the factors, wherein each weight of the individual weights indicates an importance of a factor to a priority among the first application and the second application; generating second individual scores for the factors based on the second values of the factors and the individual weights for each of the factors; generating a first combined score by combining the first individual scores, wherein the first combined score indicates a first priority level for the first application; generating a second combined score by combining the second individual scores, wherein the second combined score indicates a second priority level for the second application; and prioritizing the first application with respect to the second application based on the first combined score and the second combined score.

In some examples, the method further comprises receiving signal values, wherein the first values of the factors are based at least in part on the signal values, and wherein a value of the first values of the factors is based at least in part on a plurality of the signal values.

In some examples, the method further comprises generating the individual weights using an ML model.

In some examples, the method further comprises normalizing each of the first and second individual scores for the factors.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory comprising executable instructions that, when executed, perform operations comprising:
identifying values for a set of factors for prioritizing an allocation of network computing resources to an application among a plurality of applications;
generating a set of individual scores for the set of factors based on the values for the set of factors and an individual weight for each of the set of factors, wherein each of the individual weights indicates an importance of a corresponding factor to a priority of the application;
generating a combined score by combining the set of individual scores, wherein the combined score indicates the priority of the application; and
prioritizing the allocation of the network computing resources to the application with respect to the plurality of applications based on the combined score.

2. The system of claim 1, wherein the values for the set of factors are based at least in part on a set of signal values.

3. The system of claim 1, the operations further comprising:
generating the individual weights using a machine learning (ML) model.

4. The system of claim 1, the operations further comprising:
normalizing each of the set of individual scores for the set of factors.

5. The system of claim 1, the operations further comprising:
providing a prioritization indication for the application based at least in part on the combined score.

6. The system of claim 5, wherein the prioritization indication comprises at least one of: the combined score, a ranking of the application among the plurality of applications, or a prioritization descriptor for the application.

7. The system of claim 1, wherein the set of factors comprises at least one of: an application type, application network data usage, an application inactivity duration, or an application interactive frequency.

8. The system of claim 1, the operations further comprising:
applying a decay factor to at least one individual score of the set of individual scores.

9. The system of claim 1, the operations further comprising:
deprioritizing the application after a grace period.

10. The system of claim 1, the operations further comprising:
deprioritizing the application gradually over a time period.

11. The system of claim 1, the operations further comprising:
re-generating at least one individual score of the set of individual scores before deprioritizing the application.

12. The system of claim 1, wherein combining the set of individual scores comprises at least one of adding or subtracting at least two individual scores of the set of individual scores.

13. A system comprising:
a processor; and
memory comprising executable instructions that, when executed, perform operations comprising:
identifying values of a set of factors for prioritizing an application among a plurality of applications;
generating a set of individual scores for the set of factors based on values of the set of factors and individual weights for each of the set of factors, wherein each of the individual weights indicates importance of the factor to a priority for the application;
generating a combined score by combining the set of individual scores, wherein the combined score indicates the priority for the application; and
selecting a prioritization mechanism from a plurality of prioritization mechanisms based at least in part on the combined score.

14. The system of claim 13, wherein the selecting comprises selecting a first prioritization mechanism from the plurality of prioritization mechanisms based at least in part on the combined score being above a first threshold score, or selecting a second prioritization mechanism from the plurality of prioritization mechanisms based at least in part on the combined score being below the first threshold score.

15. The system of claim 13, the operations further comprising:
setting a quality of service (QOS) priority for the application based at least in part on the combined score.

16. The system of claim 13, wherein the factors comprise at least one of application network usage metrics, application metadata, an application priority level, application dependencies, application system resource usage, user context and behavior, a network type, or historical data.

17. A method comprising:
identifying first values of factors for prioritizing a first application with respect to a second application;
identifying second values of factors for prioritizing the second application with respect to the first application;
generating first individual scores for the factors based on the first values of the factors and individual weights for each of the factors, wherein each weight of the individual weights indicates an importance of a factor to a priority among the first application and the second application;
generating second individual scores for the factors based on the second values of the factors and the individual weights for each of the factors;
generating a first combined score by combining the first individual scores, wherein the first combined score indicates a first priority level for the first application;
generating a second combined score by combining the second individual scores, wherein the second combined score indicates a second priority level for the second application; and
prioritizing the first application with respect to the second application based on the first combined score and the second combined score.

18. The method of claim 17, further comprising:
receiving signal values, wherein the first values of the factors are based at least in part on the signal values, and wherein a value of the first values of the factors is based at least in part on a plurality of the signal values.

19. The method of claim 17, further comprising:
generating the individual weights using a machine learning (ML) model.

20. The method of claim 17, further comprising:
normalizing each of the first and second individual scores for the factors.
